(19) United States
(12) Patent Application Publication
(10) Pub. No.: US 2016/0004954 A1
(43) Pub. Date: Jan. 7, 2016

(54) Frequency tuning of an electronic tag

(71) Applicant: Commissariat A L'Energie Atomique Et Aux Energies Alternatives, Paris (FR)

(72) Inventors: Estelle LE BARON, Barraux (FR); Thierry Thomas, Varces Allieres Et Risset (FR)

(21) Appl. No.: 14/791,686

(22) Filed: Jul. 6, 2015

(30) Foreign Application Priority Data
Jul. 7, 2014 (FR) 14/56520

(51) Int. Cl. G06K 19/077; H01Q 1/22; H01Q 7/00

(52) U.S. Cl. CPC G06K 19/07783; H01Q 7/005; H01Q 1/2225

(57) ABSTRACT

An electronic tag including: a first planar conductive winding forming an antenna coupled, with or without contact, with an electronic circuit; and a correction element, placed on the first winding and having its shape and position relative to the first winding selected according to a resonance frequency correction desired for the assembly.

### BACKGROUND

The present invention generally relates to electromagnetic transponders and, more particularly, to electronic tags (RFID TAG) capable of communicating without contact with a reader. The invention more specifically relates to the setting of the frequency tuning of such electronic tags.

### DISCUSSION OF THE RELATED ART

Electronic tags are currently very widely used to exchange information without contact with a reader. Most often, such electronic tags (RFID tags) draw the power supply necessary to the circuits that they comprise from the high-frequency field radiated by the reader close to which they are located, this function being called “remote supply”.

Ideally, the tag and the reader are frequency-tuned, which optimizes the remote supply and, accordingly, the operating range of the tag.

However, due to manufacturing dispersions, two RFID tags, even originating from a same manufacturing batch, do not have the same characteristics in terms of frequency tuning This adversely affects the performance of the communication system into which they are then integrated.

On the other hand, the environmental conditions of use and the aging of electronic tags sometimes have a significant incidence upon the frequency tuning thereof.

Document U.S. Pat. No. 6,172,608 describes a system comprising an interrogator and an electronic tag. An additional antenna of larger size than the tag is coupled therewith to improve the power transfer by increasing the surface area of the antenna system.

Other documents, such as document US-A-20080224874 describe techniques for setting the frequency tuning of tags by laser trimming, which risks weakening the tag. The settings are further long and irreversible.

Document U.S. Pat. No. 6,796,508 described a RFID tag where the ends of a conductive winding are connected to a capacitive element.

Document JP-2001-160124 describes a RFID tag where a metal plate is placed close to a conductive winding.

Document JP-2002-007985 describes a method of adjusting the resonance frequency of an electronic tag.

Document JP-2003-218624 describes an amplifying antenna for an electronic tag.

### SUMMARY

An embodiment aims at overcoming all or part of the disadvantages of current electronic tags.

Another embodiment aims at adjusting the tuning frequency of an electronic tag after manufacturing.

Another embodiment aims at decreasing the frequency dispersion of tags.

Another embodiment aims at adjusting the tuning frequency of a generically manufactured electronic tag to a specific value from among a plurality thereof, dedicated to a use which is assigned thereto.

Another embodiment more specifically aims at a solution adapted to tags manufactured in large series.

Another embodiment is an inductive resonator capable of ensuring the function of reversible correction of the frequency of a tag.

Another embodiment aims at a solution more specifically adapted to an electronic tag provided with an antenna made in the form of a planar conductive winding.

Thus, an embodiment provides an electronic tag comprising:
a first planar conductive winding forming an antenna coupled, with or without contact, with an electronic circuit;
a correction element, placed on the first winding and having its shape and position relative to the first winding selected according to a resonance frequency correction desired for the assembly; and
a third winding electrically series-connected with the first winding.

According to an embodiment, the correction element is a second planar conductive winding having a smaller size than the first winding.

According to an embodiment, the ends of the second winding are non-connected.

According to an embodiment, the ends of the second winding are interconnected.

According to an embodiment, the correction element is a planar conductive ring having a size smaller than or equal to that of the first winding.

According to an embodiment, the correction element is a conductive pad having a smaller size than the first winding.

According to an embodiment, two ends of the first winding are connected across the electronic circuit, a capacitive element being connected in parallel on the first winding.

According to an embodiment, the first winding has a smaller size than the third winding.

According to an embodiment, the correction element is inscribed, in a plane, within the surface area defined by the third winding.

An embodiment also provides a method of correcting the resonance frequency of a fist winding of an electronic tag, wherein a conductive correction element is placed on the electronic tag with an interposed insulator, the position of the correction element relative to the first winding being determined from the measurement of the resonance frequency of the complete tag.

### BRIEF DESCRIPTION OF THE DRAWINGS

The foregoing and other features and advantages will be discussed in detail in the following non-limiting description of specific embodiments in connection with the accompanying drawings, in which:

FIG. 1 is a very simplified representation of a communication system using an electronic tag;

FIG. 2 is a simplified diagram of an embodiment of an electronic tag;

FIG. 3 illustrates an embodiment of the sizing of a tuning frequency correction element;

FIGS. 4A, 4B, 4C, and 4D are simplified representations of an embodiment of an antenna equipped with a correction element in different positions of the correction element;

FIG. 5 shows the equivalent electric diagram of an electronic tag according to the embodiment of FIGS. 4A to 4D;

FIGS. 6A and 6B illustrate two positions of an element for correcting the tuning frequency of an electronic tag;

FIG. 7 illustrates an example of response of the coupling coefficient according to a position shift of a correction antenna;

FIG. 8 illustrates the influence on the tuning frequency of a variation of the position of the correction element;

FIG. 9 shows another embodiment of an element for correcting the resonance frequency of an electronic tag; and

FIG. 10 very schematically shows an embodiment of an installation for positioning correction elements on electronic tags.

### DETAILED DESCRIPTION

The same elements have been designated with the same reference numerals in the different drawings. For clarity, only those steps and elements which are useful to the understanding of the embodiments which will be described have been shown and will be detailed. In particular, the practical forming of the planar conductive windings forming the antennas has not been detailed, the described embodiments being compatible with usual techniques. Further, electronic circuits for using signals captured and transmitted by an electronic tag or by a reader have not been detailed either, the described embodiments being here again compatible with usual circuits.

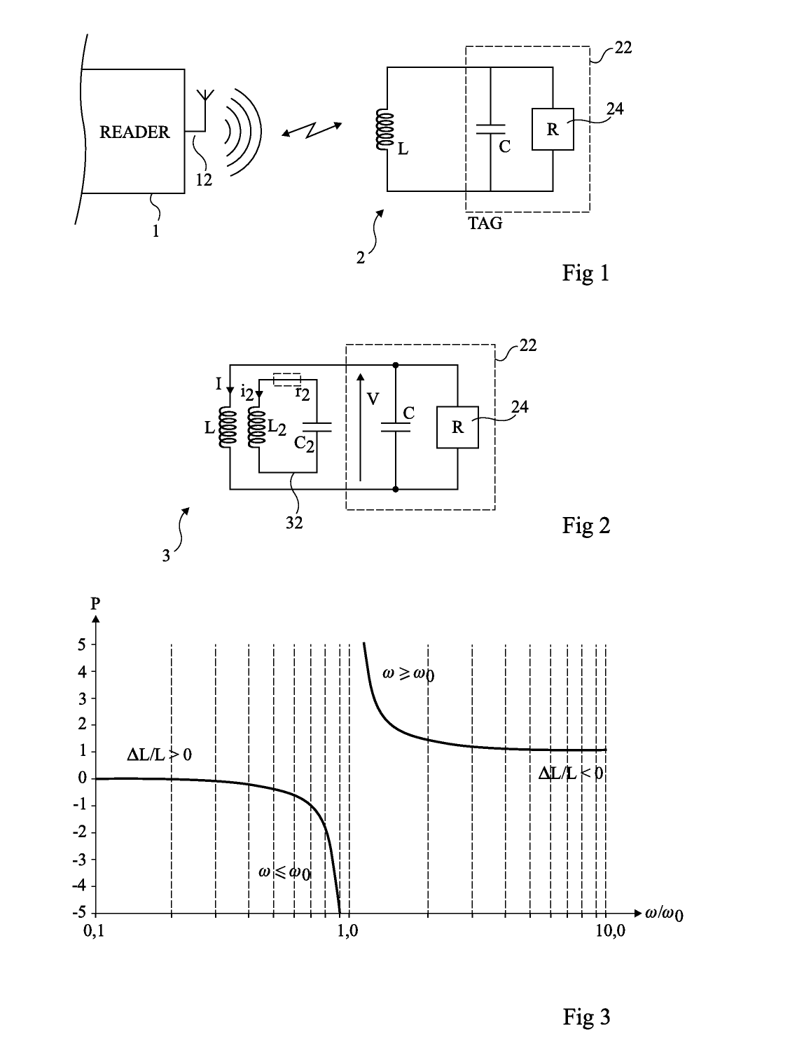

FIG. 1 is a very simplified representation of a contactless communication system of electromagnetic transponder type.

A reader 1 (READER) emits via an antenna 12 a radio frequency field intended to be captured by one or a plurality of electromagnetic transponders located within its range. In the example of FIG. 1, the transponder is an electronic tag 2 (TAG) comprising an antenna L in the form of a planar conductive winding and, connected across this antenna, a capacitive element C and a load 24 (R). The load represents the antenna losses (LC circuit) and the power consumption of the electronic circuit associated with the antenna. Element C aims at forming, with antenna L, an oscillating circuit (in this example, parallel). Load 24 is, according to applications, more or less sophisticated. It may be a passive load (for example, resistive) or an active integrated circuit. In practice, capacitive element C is most often integrated, with load 24, in a same chip 22. The assembly forms a resonant circuit at a tuning frequency in the electromagnetic field. The tag may comprise no integrated circuit and be purely passive (LC). Generally, electric tags draw the power necessary for the operation of the circuits (R) that they comprise from the electromagnetic field radiated by terminal or reader 1 (READER).

There exist many different systems, particularly according to the standards that they meet (for example, ISO15693, ISO18000-3).

Most often, for a transmission from the reader to the transponder, the reader modulates the high-frequency carrier that it transmits. In the tag-to-reader direction, the transponder modifies the load that it forms on the oscillating circuit of the reader. Such a load variation is then detected (in phase or amplitude modulation) by the reader circuits.

Ideally, the oscillating circuit of the reader and the resonant circuit of the tag are tuned to a same frequency: the frequency of the electromagnetic field emitted by reader 1 (for example, 13.56 MHz in the case of the above-mentioned standards).

In practice, when the tags are manufactured in series, technological dispersions create non-negligible differences in terms of resonance frequency variation of the tag. This also generates differences in terms of performance from one electronic tag to another, said tags being then off-tune with respect to the operating frequency of the system for which they are provided.

Typically, for a 13.56-MHz operating frequency, resonance frequency differences ranging up to several hundred kilohertz between two tags originating from the same manufacturing have been observed.

FIG. 2 shows an embodiment of an electronic tag 3. As compared with tag 2 of FIG. 1, a second oscillating circuit, resonant at an operating frequency much greater or much smaller than that of the tag, is added. Such a passive resonator is in coupling relation with the LC oscillating circuit of the tag. From an electric viewpoint, resonator 32 comprises an inductive winding L₂ across which a capacitance C₂ is connected. The equivalent electric circuit comprises a resistor r₂ (in dotted lines in FIG. 2) in series with the two other elements. In practice, resistor r₂ corresponds to the linear resistance of conductive winding L₂ and to the dielectric losses of capacitive element C₂. Similarly, capacitive element C₂ preferably corresponds to the stray capacitances of conductive winding L₂ in relation with the insulating substrate which supports it.

In practice, conductive winding L₂ is a planar conductive winding formed on an insulating substrate, the assembly being placed on or close to electronic tag (of type 2, FIG. 1) to form a tag 3 integrating the two elements. “Close” means that winding L₂ is in a plane parallel to that containing the rest of the tag, the distance between planes being at most a few millimeters.

The presence of resonator element 32 enables to increase or to decrease the resonance frequency of the tag.

The fact of adding a passive resonator in the form of a stamp or of a pad formed separately and placed on a series production tag enables to correct the resonance frequency and to compensate for manufacturing drifts in particularly simple fashion. In particular, this requires no intervention on the actual series production of basic electronic tags. Further, no intervention on the reader is necessary.

Adding a passive resonator also enables to pool the manufacturing for a generic tag and then to finalize the tags according to various target tuning frequency values according to their final use mode, to take into account the influence of the materials on which they will be applied, or to take into account the shape that they will take, for example, flat or curved in the form of a tile on a pipe.

In a simplified embodiment, correction element 32 is formed of a simple conductive pad placed on the tag with an interposed insulating layer.

The sizing of the correction element depends on the electric resonance characteristics of the oscillating circuit of the tag.

As compared with other solutions, an advantage is the lack of physical intervention on the main oscillating circuit of the tag, conversely to cutting or trimming solutions, which are irreversible, sometimes long (the number of settings is known at the end of the adjustment only) and which make the tag more fragile (piercing and protection). Another advantage of the provided solution is that it enables to proceed by tests, confirmations, and then gluing, which is more flexible than an implementation of a setting by successive trimmings.

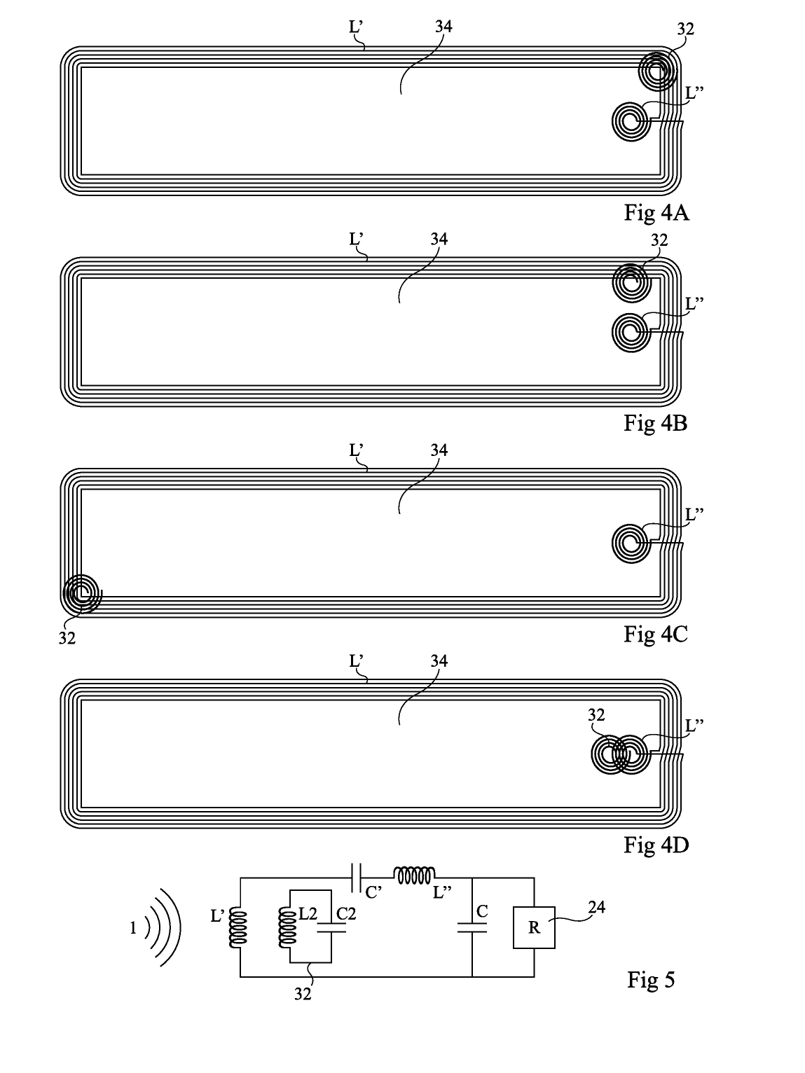

Hereafter, the following references will be used:
L, for the inductance of the tag with no resonant element 32 (L represents, in the case of FIG. 2, inductance L of the oscillating circuit or, in the case of more complex tags as will be seen hereafter in relation with FIG. 4 and the following, the inductance of the general tag circuit);
C, for the equivalent capacitance value associated with inductance L to form resonator LC (capacitor C of circuit 22 in the case of FIG. 2).
V, for the voltage across inductive element L (and thus across capacitive element C);
I, for the current in inductance L;
L₂, for the inductance of resonant element or circuit 32;
C₂, for the capacitance of element 32;
r₂, for ohmic losses in element 32;
Z₂, for the impedance of resonant circuit 32;
i₂, for the current in resonant circuit 32;
k, for the coupling coefficient between windings L and L₂;
M, for the mutual inductance between windings L and L₂;
ω, for the pulse of circuit LC; and
ω₀, for the resonance pulse of resonant circuit 32.

The following formulas can be written:

$$\begin{matrix}V = j \cdot M ω \cdot {i}_{2} + j \cdot L ω \cdot I & formula 1 \\ j \cdot M ω \cdot I = - {Z}_{2} \cdot {i}_{2} & formula 2 \\ = {r}_{2} + j \cdot {L}_{2} ω + \frac{1}{j \cdot {C}_{2} ω} & formula 3 \\ M = k \cdot \sqrt{L \cdot {L}_{2}} & formula 4\end{matrix}$$

According to quality factor Q, pulse ω₀ at the resonance (2πf₀, where f₀ represents the resonance frequency) is given by the following relations:

$$\begin{matrix}{C}_{2} {ω}_{0}^{2} = 1 & formula 5 \\ Q = \frac{1}{{r}_{2}} \sqrt{\frac{{L}_{2}}{{C}_{2}}} & formula 6\end{matrix}$$

In usual fashion, the following relations expressing apparent impedance Z′ of inductance L under the influence of correction element 32 can also be established:

$$\begin{matrix}V = j \cdot M ω \cdot {i}_{2} + j \cdot L ω \cdot I = ( \frac{{M}^{2} {ω}^{2}}{{Z}_{2}} + j \cdot L ω ) \cdot I \\ = ( \frac{{M}^{2} {ω}^{2}}{{Z}_{2}} + j \cdot L ω ) formula 8\end{matrix} \qquad formula 7$$

Impedance Z₂ can thus be written as:

$$= {r}_{2} + j \cdot {L}_{2} ω + \frac{1}{j \cdot {C}_{2} ω} = {r}_{2} \cdot ( 1 + j \cdot Q \cdot ( \frac{ω}{{ω}_{0}} - \frac{{ω}_{0}}{ω} ) ) \qquad formula 9$$

The sizing of correction element 32 may be performed by applying literal formulas. However, to simplify the industrial implementation, the inventors consider that certain approximations may be made and that such approximations are particularly relevant.

A first approximation is to consider that the ohmic losses (r₂) of correction circuit 32 may be negligible, which amounts to saying that quality factor Q is much greater than 1. Impedance Z₂ can thus be expressed as:

$$\approx j \cdot {r}_{2} Q \cdot ( \frac{ω}{{ω}_{0}} - \frac{{ω}_{0}}{ω} ) = j \cdot \sqrt{\frac{{L}_{2}}{{C}_{2}} \cdot } ( \frac{ω}{{ω}_{0}} - \frac{{ω}_{0}}{ω} ) \qquad formula 10$$

A second simplification is to distinguish two cases according to whether resonance frequency f₀ of correction circuit 32 is greater or smaller than the desired operating frequency f (tuning frequency desired for the transponder system where the tag should operate).

In the first case (f₀>f), impedance Z₂ can be expressed as:

$$\approx - j \cdot {r}_{2} Q \cdot \frac{{ω}_{0}}{ω} = - j \cdot \sqrt{\frac{{L}_{2}}{{C}_{2}} \cdot } \frac{{ω}_{0}}{ω} \qquad formula 11$$

Using above formulas 7 and 8 then enables to write:

$$\begin{matrix}\begin{matrix} = ( \frac{{M}^{2} {ω}^{2}}{{Z}_{2}} + j \cdot L ω ) = ( j \cdot L ω + \frac{{M}^{2} {ω}^{2}}{- j \cdot {r}_{2} Q \cdot \frac{{ω}_{0}}{ω}} ) \\ = ( j \cdot L \cdot ω + j \cdot \frac{{M}^{2} {ω}^{2}}{{r}_{2} Q \cdot {ω}_{0}} ) \cdot ω\end{matrix} & formula 12 \\ = ( \frac{{M}^{2} {ω}^{2}}{{Z}_{2}} + j \cdot L ω ) = j \cdot ( L + M \cdot \frac{M {ω}_{0}}{{r}_{2} Q} \cdot {( \frac{ω}{{ω}_{0}} )}^{2} ) \cdot ω & formula 13\end{matrix}$$

It can then be considered that inductance L is artificially increased by correction element 32 by the following value:

$$Δ L = M \cdot \frac{M {ω}_{0}}{{r}_{2} Q} \cdot {( \frac{ω}{{ω}_{0}} )}^{2} \qquad formula 14$$

Or, by using formulas 5 and 6:

$$Δ L = M \cdot \frac{M {ω}_{0}}{{L}_{2} {ω}_{0}} \cdot {( \frac{ω}{{ω}_{0}} )}^{2} = {k}^{2} \cdot L \cdot {( \frac{ω}{{ω}_{0}} )}^{2} \qquad formula 15$$

It is also possible to express the ratio of variation ΔL of the inductance value to value L by the following function

$$= + {k}^{2} \cdot {( \frac{ω}{{ω}_{0}} )}^{2} \qquad formula 16$$

Coupling coefficient k depends on the position of the correction antenna or pad with respect to main antenna L.

In the second case, where the resonance frequency of correction circuit 32 is much lower than the operating frequency (f₀<f), above relations 11 to 16 become the following relations:

$$\begin{matrix}\begin{matrix} \approx j \cdot {r}_{2} Q \cdot \frac{ω}{{ω}_{0}} \\ = ( \frac{{M}^{2} {ω}^{2}}{{Z}_{2}} + j \cdot L ω ) = ( j \cdot L ω + \frac{{M}^{2} {ω}^{2}}{( j \cdot {r}_{2} Q \cdot \frac{ω}{{ω}_{0}} )} )\end{matrix} & formula {11}^{′} \\ = ( j \cdot L - j \cdot \frac{{M}^{2}}{( {r}_{2} Q \cdot {ω}_{0} )} \cdot ω ) & formula {12}^{′} \\ = ( \frac{{M}^{2} {ω}^{2}}{{Z}_{2}} + j \cdot L ω ) = j \cdot ( L - M \cdot \frac{M {ω}_{0}}{{r}_{2} Q} ) \cdot ω & formula {13}^{′} \\ Δ L = - M \cdot \frac{M {ω}_{0}}{{r}_{2} Q} & formula {14}^{′} \\ Δ L = - M \cdot \frac{M {ω}_{0}}{{L}_{2} {ω}_{0}} = - {k}^{2} \cdot L & formula {15}^{′} \\ = - {k}^{2} & formula {16}^{′}\end{matrix}$$

With no approximation, the literal expression of ratio ΔL/L according to pulses ω and ω₀ can be expressed as follows:

$$= - {k}^{2} \cdot \frac{( \frac{ω}{{ω}_{0}} )}{( ( \frac{ω}{{ω}_{0}} - \frac{{ω}_{0}}{ω} ) - j \cdot \frac{1}{Q} )} \qquad formula 17$$

This formula can be deduced from the previous general expressions. Considering a high quality factor Q (of at least 10), this expression can be simplified into the following expression:

$$= - {k}^{2} \cdot \frac{( \frac{ω}{{ω}_{0}} )}{( \frac{ω}{{ω}_{0}} - \frac{{ω}_{0}}{ω} )} \qquad formula 18$$

FIG. 3 shows the variation of factor p:

$$p = \frac{( \frac{ω}{{ω}_{0}} )}{( \frac{ω}{{ω}_{0}} - \frac{{ω}_{0}}{ω} )} \qquad formula 19$$

according to ratio ω/ω₀.

As appears from FIG. 3, according to whether the desired value of the tuning frequency is lower than value f₀ (left-hand portion in the drawing) or greater than this value (right-hand portion in the drawing), coefficient p is negative or positive, whereby the signs expressed previously in formulas 16 and 16′ can be found.

According to a preferred mode of sizing and positioning of correction element 32 with respect to the antenna, the following steps are implemented.

The target frequency corresponding to the tuning frequency of the system for which the tag is intended (generally, the radio frequency carrier frequency) is known.

Based on the measured frequency of the electronic tag with no correction element, the frequency interval which should be corrected (Δf), or pulse difference Δω, is determined.

A correction element 32 having a resonance frequency f₀ compatible with the sign of the desired correction is then selected.

Finally, its distance or its position relative to the tag antenna is selected. A position in a plane parallel to that of the rest of the tag relative to the pattern followed by the conductive circuit of its antenna is preferably selected, to keep the tag in the form of an object having a small thickness.

The smaller the size of the correction element with respect to the antenna size, the lower the available range of coupling coefficients k with respect to the position of this correction, but this makes the positioning thereof easier.

According to an embodiment where, for a given manufacturing, a plurality of correction elements having different inductance values is available, the inductance interval due to manufacturing dispersions can be determined. The compensation to be performed (ΔL/L) can be deduced therefrom. The correction element which is located in the possible correction range is then selected from a set of correction elements. Then, the correction is refined by the position of this correction element relative to the tag antenna. The coupling coefficient is then only due to geometric considerations since there is no electric connection between antenna L and element L₂.

In a simplified embodiment, a same correction element is used for a whole production batch (set frequency f0, pulse ω₀), and only the setting of the position of the correction element relative to the tag antenna, which conditions the coupling coefficient and thus the correction, is performed.

The position of the correction element may be, on manufacturing, determined from charts established in test phases.

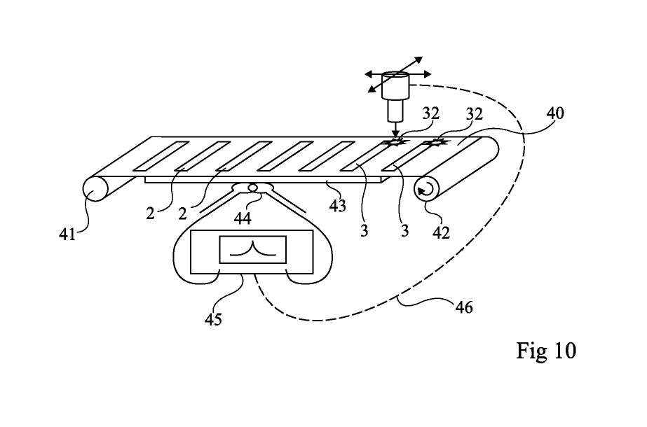

According to another embodiment which will be illustrated in relation with FIG. 10, this position is determined based on real measurements.

FIGS. 4A, 4B, 4C, and 4D are simplified top views of an embodiment of an antenna L of an electronic tag associated with a correction element 32. According to this embodiment, an antenna L′ is intended to capture the field of a reader and is associated with an intermediate coil L″ intended for the connection with the internal transponder circuits (capacitance C and load R). For the application of the above-described formulas, inductance L corresponds to the inductance of series-connected coils L′ and L″.

FIG. 5 shows the simplified equivalent electric diagram of the tag of FIG. 4. Inductance L″ is generally of small size with respect to inductance L′ and is electrically in series therewith, with an interposed capacitive element C′. The series association of inductance L′ of element C′ and of inductance L″ is connected to integrated circuits (load R) and comprises between its terminals a capacitive element C. Taking the example of this embodiment of FIG. 5, notation C to which reference is made in relation with the above-described formulas (circuit LC having a pulse equal to ω) corresponds to the series connection of elements C and C′.

Other embodiments of a tag with two conductive windings exist, and what will be described hereafter applies to these different embodiments. Among these, the following cases should be noted:
the two coils L′ and L″ are electrically in series, the assembly is connected to integrated circuit 22 containing capacitance C, to form a simple RLC resonator. The distinction between the two coils is purely geometrical.
the two coils L′ and L″ are electrically in series, the assembly being closed on itself, an additional coil is connected to integrated circuit 22 containing capacitance C, to form a simple RLC resonator, called “module”. This additional coil and coil L″ are inductively coupled. Such is the case of FIG. 5.
coil L′ is associated with a series capacitance C′ (or a plurality of series capacitances), or the coil is formed by “resonant” lines, to form a first resonator. Coil L″ is connected to integrated circuit 22 containing capacitance C to form a second resonator, called “module”. The two resonators are electrically interconnected to form an RLC resonator.
the two coils L′ and L″ are electrically in series, in association with a capacitance C′ or a plurality of series-connected capacitances, the assembly is closed on itself. An additional coil is connected to integrated circuit 22 containing capacitance C, to form a simple RLC resonator, called “module”. This additional coil and coil L″ are inductively coupled. The assembly forms a complex resonator equivalent to two coupled simple resonant circuits.
the two coils L′ and L″ are electrically in parallel, in association with a parallel capacitance C′, to form a first RLC resonator. An additional coil is connected to integrated circuit 22 containing capacitance C, to form a second RLC resonator, called “module”. This additional coil and coil L″ are inductively coupled, the assembly forms a complex resonator equivalent to two coupled simple resonant circuits.

For structures with no additional coil, the mutual coupling is performed between windings L₂ and L′, between L₂ and L″, or both. For example, in the cases where windings L′ and L″ are electrically in series (they conduct a same current), the respective inductances then are “partial” inductance corresponding to two portions of a general winding of an inductance L (L=L′+L″+2.M′, wherein M′ is the mutual inductance between the two windings L′ and L″). What matters for the setting by correction element 32 is the value of the coupling between coil L₂ and general coil L, whether this coupling originates from the proximity between windings L₂ and L′ or between windings L₂ and L″. The formulas described in relation with the example of FIG. 2 apply, considering general inductance L.

In such systems, inductance L′ is intended to capture the field originating from reader 1. Correction element 32 is intended to correct possible manufacturing dispersions of inductance L′ of relatively large size as compared with the size of inductances L″ and L₂. Inductance L″ forms a transmission antenna (in the same way as a transformer for electronic circuits for processing the received information). In the example illustrated in FIGS. 4A to 4D, winding L₂ forming correction element 32 has approximately the same size as winding L″.

As illustrated in FIGS. 4A to 4D, correction element 32 may be placed at different locations on the electronic tag, in a plane parallel to its planar winding L′, according to the desired correction.

The minimum coupling coefficient will be obtained for a correction element 32 placed at the center of winding L′.

In the example of FIG. 5, the maximum coupling will be obtained for a positioning of winding L₂ on winding L″ (of course with the interposition of insulator 34 forming the substrate).

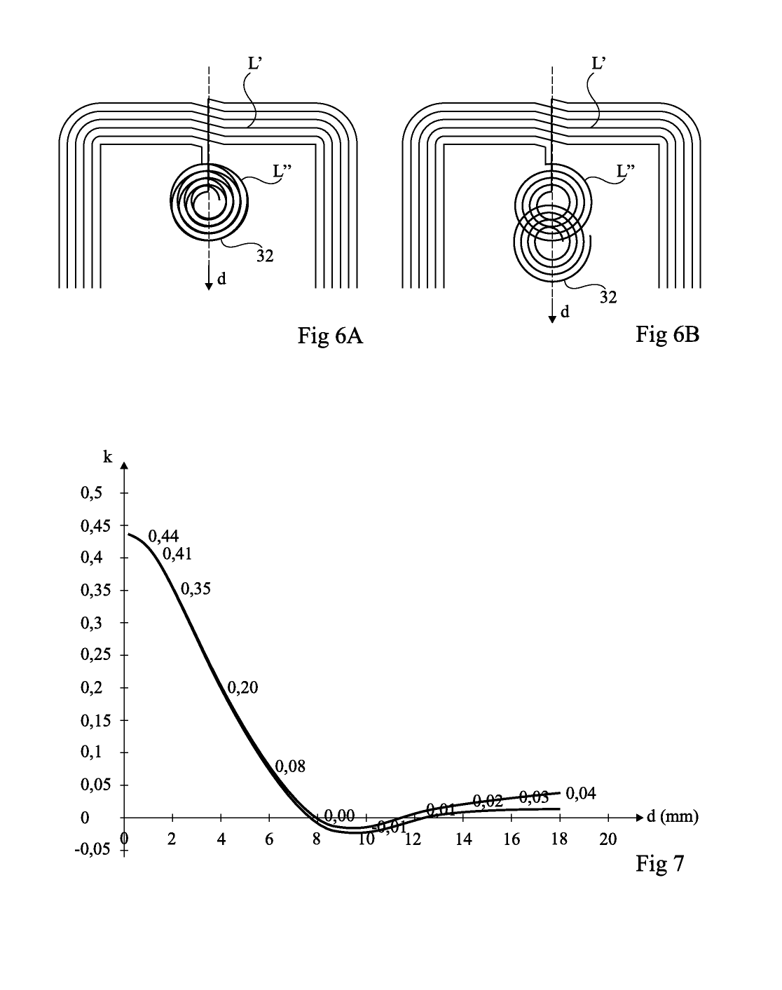

FIGS. 6A and 6B illustrate, in partial views of the electronic tag, two other modes of placement of correction element 32. FIG. 6A illustrates the case of a maximum coupling. FIG. 6B illustrates another case where the pad forming winding L₂ at least partially covers winding L″.

FIG. 7 illustrates an example of shape of coupling coefficient k according to the spacing (distance in mm) towards the inside of winding L′ (symbolized by an arrow d in FIGS. 6A and 6B). As shown in this drawing, the highest coupling coefficients (between 0.05 and 0.45) are obtained for a distance shorter than 6 mm.

The specific example shown in FIGS. 4, 6, 7, and 8 relates to the case of:
an inductance L′ having the following dimensions:
   average length: 222 mm;
   average width: 52.5 mm;
   number of spirals: 6;
   pitch between spirals: 1.25 mm;
   spiral width: 0.85 mm;
   spiral thickness: 0.035 mm;
an inductance L″, formed by a structure of two stacked windings such as described in document FR-A-2961353, having the following dimensions:
   inner diameter: 5.6 mm;
   outer diameter: 12.4 mm;
   pitch between spirals: 0.4 mm;
   number of layers: 2;
   number of spirals: 2×9; and
an inductance L2, formed by a structure of two stacked windings such as described in document FR-A-2961353, having the following dimensions:
   inner diameter: 5.2 mm;
   outer diameter: 13.2 mm;
   pitch between spirals: 0.4 mm;
   number of layers: 2;
   substrate: 50 μm polyimide;
   number of spirals: 2×10.

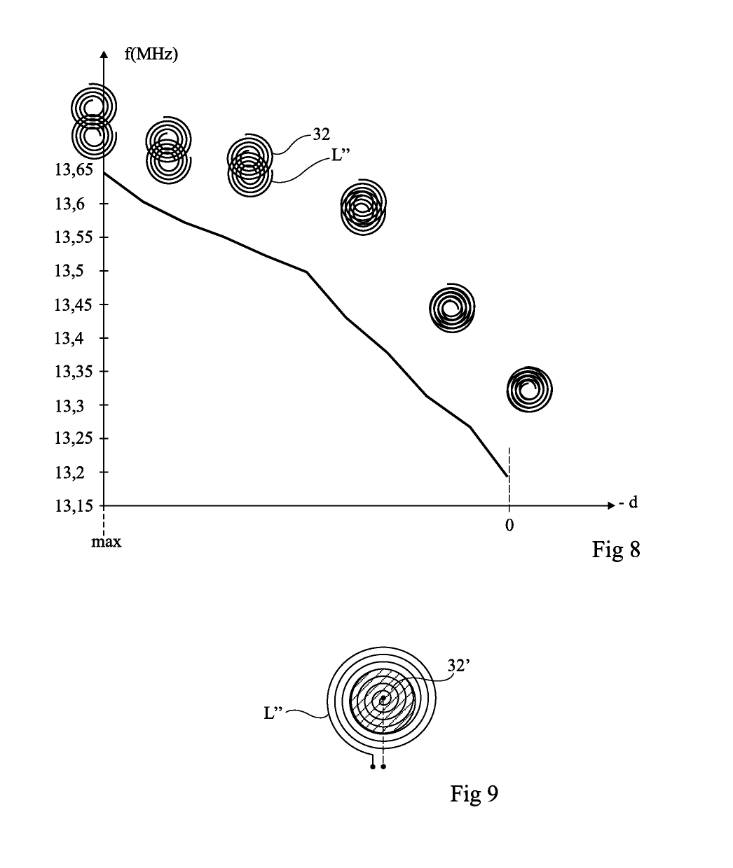

FIG. 8 illustrates the resonance frequency variation obtained according to the overlapping of a correction element 32 on a winding L″ such as illustrated in FIGS. 4 and 6, in the case of an antenna intended for a 13.56-MHz frequency.

As appears from FIG. 8, according to the layout of element 32 (total superposition d=0 or maximum shift d=max on the end of winding L″), the resonance frequency obtained for the assembly is in the range from 13.2 MHz to 13.65 MHz.

The description of FIGS. 4 to 8 illustrates an example enabling to better grasp the possibilities offered by the described embodiments, but other positions can be envisaged for correction element 32.

FIG. 9 illustrates an alternative embodiment according to which correction element 32 is a solid conductive pad 32′ rather than a conductive winding, for a negative correction (ΔL/L<0). Indeed, a correction element having a very low resonance frequency f0 may be, in an extreme case, a shorted coil (f0=0). A conductive pad is the very simple equivalent embodiment of a shorted coil.

FIG. 10 very schematically shows an embodiment of an installation for positioning correction elements 32 on electronic tags 2 in a series production.

According to this example, electronic tags 2 are manufactured on a flexible substrate and appear, before cutting, in the form of a band 40 wound in a coil of tags 2. In the installation for the positioning of tags 2, band 40 is unwound from a roll 41 to be wound on a roll 42 after passing on a table 43 for assembling correction elements 32. At the lower surface, table 43 is fitted with a head 44 of a device 45 for measuring the tuning frequency of tag 2. This device controls (connection 46) the position of a distributor 46 of correction elements 32 relative to tag 2 during a test. Once the desired tuning has been obtained, pad 32 is, for example, glued on tag 2 which becomes corrected tag 3.

An advantage of the embodiments which have been described is that it is now possible to correct antenna manufacturing contingencies to compensate for the tuning frequency dispersion.

Another advantage of the described embodiments is that the correction is particularly easy to implement and requires no intervention on the manufacturing of the actual main tag. In particular, the correction may be performed independently from the manufacturing.

Various alterations, modifications, and improvements will readily occur to those skilled in the art. In particular, the conductive windings are of course in practice supported by insulating substrates and are insulated from one another. The insulator thickness has an influence upon the coupling factor.

Further, the practical implementation of the described embodiments is within the abilities of those skilled in the art based on the functional indications given hereabove, be it for the sizing of the correction element to be provided or for the positioning thereof.

1. An electronic tag comprising:
a first planar conductive winding forming an antenna coupled, with or without contact, with an electronic circuit;
a correction element, placed on the first winding and having its shape and position relative to the first winding selected according to a resonance frequency correction desired for the assembly; and
a third winding electrically series-connected with the first winding.

2. The electronic tag of claim 1, wherein the correction element is a second planar conductive winding having a smaller size than the first winding.

3. The electronic tag of claim 2, wherein the ends of the second winding are non-connected.

4. The electronic tag of claim 2, wherein the ends of the second winding are interconnected.

5. The electronic tag of claim 1, wherein the correction element is a planar conductive ring having a size smaller than or equal to that of the first winding (L).

6. The electronic tag of claim 1, wherein the correction element is a conductive pad having a smaller size than the first winding.

7. The electronic tag of claim 1, wherein two ends of the first winding are connected across the electronic circuit, a capacitive element being connected in parallel on the first winding.

8. The electronic tag of claim 1, wherein the first winding has a smaller size than the third winding.

9. The electronic tag of claim 8, wherein the correction element is inscribed, in a plane, within the surface area defined by the third winding.

10. A method of correcting the resonance frequency of a first winding of an electronic tag, wherein a conductive correction element is placed on the electronic tag with an interposed insulator, the position of the correction element relative to the first winding being determined from the measurement of the resonance frequency of the complete tag.
